(19) United States
(12) Patent Application Publication
(10) Pub. No.: US 2020/0190451 A1
(43) Pub. Date: Jun. 18, 2020

(54) MULTI-LEVEL TOASTED WINE BARREL AND STAVES

(71) Applicant: Mirage Business Capital Inc. c/o Harneys Corporate Services Ltd., Road Town (VG)

(72) Inventor: James Molnar, Palm Beach Gardens, FL (US)

(21) Appl. No.: 16/218,915

(22) Filed: Dec. 13, 2018

(51) Int. Cl. C12H 1/22; B65D 8/00; C12G 1/00

(52) U.S. Cl. CPC C12H 1/22; C12G 1/00; B65D 9/04

(57) ABSTRACT

The present disclosure relates generally to toasted barrels or staves for aging wine. In particular, the present disclosure provides toasted barrels and staves for providing a wine contact surface having at least two crosswise portions to address the need for providing multiple flavor profiles releasable from a toasted barrel or stave, wherein the toasted barrel or stave includes multi-levels of toasting. The toasted barrel comprises a plurality of staves forming a barrel body having a wine contact surface. The barrel body includes at least a first crosswise portion and a second crosswise portion. The wine contact surface of the first crosswise portion is characterized by a first structural toast level and the wine contact surface of the second crosswise portion is characterized by a second structural toast level. The first and second structural toast levels are configured to release first and second flavor profiles, respectively, extractable to the wine.

### FIELD OF THE DISCLOSURE

The present disclosure relates generally to toasted wine barrels, staves, and systems for use in wine production. In particular, the present disclosure provides a multi-level toasted stave or barrel system configured to release at least two flavor profiles extractable to the wine.

### BACKGROUND

The demand for more complex flavor profiles derived from wood barrels for wine production is ever increasing. Wine barrels are toasted to impart flavor profiles to the wine during aging. Uniformity in toasting of barrels has been previously desired by wine producers in order to ensure consistency of product.

### SUMMARY

These and other needs are addressed by the various aspects and configurations of the present disclosure.

Various aspects of the present disclosure include a toasted barrel for aging wine, the toasted barrel comprising a plurality of staves oriented parallel to a longitudinal axis, the plurality of staves forming a barrel body having a wine contact surface, the barrel body having at least a first crosswise portion and a second crosswise portion, wherein the wine contact surface of the first crosswise portion is characterized by a first structural toast level and the wine contact surface of the second crosswise portion is characterized by a second structural toast level, the first structural toast level configured to release a first flavor profile extractable to the wine and the second structural toast level configured to release a second flavor profile extractable to the wine.

The toasted barrel for aging wine described herein above, further comprising a third crosswise portion, wherein the wine contact surface of the third crosswise portion is characterized by a third structural toast level, the third structural toast level configured to release a third flavor profile extractable to the wine.

The toasted barrel(s) for aging wine described herein above, further comprising a fourth crosswise portion, wherein the wine contact surface of the fourth crosswise portion is characterized by a fourth structural toast level, the fourth structural toast level configured to release a fourth flavor profile extractable to the wine.

The toasted barrel(s) for aging wine described herein above, further comprising a fifth crosswise portion, wherein the wine contact surface of the fifth crosswise portion is characterized by a fifth structural toast level, the fifth structural toast level configured to release a fifth flavor profile extractable to the wine.

The toasted barrel(s) for aging wine described herein above, wherein the structural toast level increases along the barrel body in a first direction from the first crosswise portion to the second crosswise portion.

The toasted barrel(s) for aging wine described herein above, further comprising a first heading inner surface and a second heading inner surface each characterized by at least the first structural toast level.

The toasted barrel(s) for aging wine described herein above, wherein the staves are made of oak.

The toasted barrel(s) for aging wine described herein above, wherein oxygen is retained within the oak.

The toasted barrel(s) for aging wine described herein above, wherein the oxygen content retained within the second crosswise portion is higher than the oxygen content retained within the first crosswise portion.

The toasted barrel(s) for aging wine described herein above, wherein the tannin content retained within the second crosswise portion is less than the tannin content retained within the first crosswise portion.

The toasted barrel(s) for aging wine described herein above, wherein the first flavor profile includes at least one flavor characteristic chosen from earthy wood characters, complex baked aromas, mild vanilla component, and combinations thereof; the second flavor profile includes at least one flavor characteristic chosen from toasty aromas of vanillin, coffee and freshly baked bread; round, sweet oak flavors and notes of spice, butterscotch, vanilla, caramel and chocolate; and combinations thereof; the third flavor profile includes at least one flavor characteristic chosen from hazelnut, spice, minerality, mild oak, and combinations thereof; the fourth flavor profile includes at least one flavor characteristic chosen from vanilla bean, hazelnut, spice, chocolate mocha, oak lactone, brown sugar, and combinations thereof; and, the fifth flavor profile includes at least one flavor characteristic chosen from touch of black pepper, mild oak lactones, espresso note, and combinations thereof.

Various aspects of the present disclosure include a toasted stave for use in a barrel for aging wine, the toasted stave comprising an elongated body portion having: a first end and a second end opposite to the first end, an inner surface, and an outer surface; wherein the inner surface includes a gradient in a first direction from the first end to the second end, wherein the gradient is an increase in the level of toasting.

The toasted stave(s) for use in a barrel for aging wine described herein above, further comprising the gradient having at least two different levels of toasting including a first level of toasting, and a second level of toasting, the second level of toasting greater than the first level of toasting.

The toasted stave for use in a barrel for aging wine described herein above, further comprising a third level of toasting, the third level of toasting greater than the second level of toasting.

The toasted stave(s) for use in a barrel for aging wine described herein above, further comprising a fourth level of toasting, the fourth level of toasting greater than the third level of toasting.

The toasted stave(s) for use in a barrel for aging wine described herein above, further comprising a fifth level of toasting, the fifth level of toasting greater than the fourth level of toasting.

The toasted stave(s) for use in a barrel for aging wine described herein above, wherein the gradient from the first end to the second end is continuous.

The toasted stave(s) for use in a barrel for aging wine described herein above, wherein the gradient from the first end to the second end is discontinuous.

The toasted stave(s) for use in a barrel for aging wine described herein above, wherein the first level of toasting is untoasted.

The toasted stave(s) for use in a barrel for aging wine described herein above, wherein the stave is made of oak, and wherein oxygen is retained within the oak, wherein the inner surface further comprises an oxygen content gradient in a first direction from the first end to the second end, wherein the oxygen content gradient is an increase in the oxygen content retained within the oak.

The toasted stave(s) for use in a barrel for aging wine described herein above, wherein the inner surface further comprises a color gradient in a first direction from the first end to the second end, wherein the color gradient is an increase in the darkness of the color.

These and other advantages will be apparent from the disclosure of the aspects and configurations contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁—Xₙ, Y₁—Yₘ, and Z₁-Zₒ, the phrase is intended to refer to a single element selected from X, Y, and Z, a combination of elements selected from the same class (for example, X₁ and X₂) as well as a combination of elements selected from two or more classes (for example, Y₁ and Zₒ).

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

It should be understood that every maximum numerical limitation given throughout the present disclosure is deemed to include each and every lower numerical limitation as an alternative, as if such lower numerical limitations were expressly written herein. Every minimum numerical limitation given throughout the present disclosure is deemed to include each and every higher numerical limitation as an alternative, as if such higher numerical limitations were expressly written herein. Every numerical range given throughout the present disclosure is deemed to include each and every narrower numerical range that falls within such broader numerical range, as if such narrower numerical ranges were all expressly written herein.

The preceding is a simplified summary of the disclosure to provide an understanding of some aspects of the disclosure. This summary is neither an extensive nor exhaustive overview of the disclosure and its various aspects and configurations. It is intended neither to identify key or critical elements of the disclosure nor to delineate the scope of the disclosure but to present selected concepts of the disclosure in a simplified form as an introduction to the more detailed description presented below. As will be appreciated, other aspects and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects and configurations of the disclosure, as illustrated by the drawings referenced below.

FIG. 1 includes a perspective view of a toasted barrel according to an aspect of the present disclosure.

FIG. 2 includes a cutaway view of a toasted barrel according to an aspect of the present disclosure.

FIG. 3 includes a cutaway view of a toasted barrel having two crosswise portions according to an aspect of the present disclosure.

FIG. 4 includes a cutaway view of a toasted barrel having three crosswise portions according to an aspect of the present disclosure.

FIG. 5 includes a cutaway view of a toasted barrel having four crosswise portions according to an aspect of the present disclosure.

FIG. 6 includes a cut-away view of a toasted barrel having five crosswise portions according to an aspect of the present disclosure.

FIG. 7 includes a cutaway view of a toasted barrel having two headings according to an aspect of the present disclosure.

FIG. 8 includes a top view of a toasted stave having a gradient according to an aspect of the present disclosure.

### DETAILED DESCRIPTION

The present disclosure relates generally to toasted wine barrels, staves, and systems for use in wine production. In particular, the present disclosure provides a multi-level toasted stave or barrel system configured to release at least two flavor profiles extractable to the wine. The present disclosure addresses the need for delivering multiple, complex flavor profiles derived from a single wood barrel for wine production by providing a multi-level toasted wine barrel, and obviates the need for moving wine between barrels during aging in attempt to achieve such an effect.

Various aspects of the present disclosure include multi-level toasted wine barrel 100 comprising a plurality of staves 110 forming a body portion inner circumferential surface that is the wine contact surface.

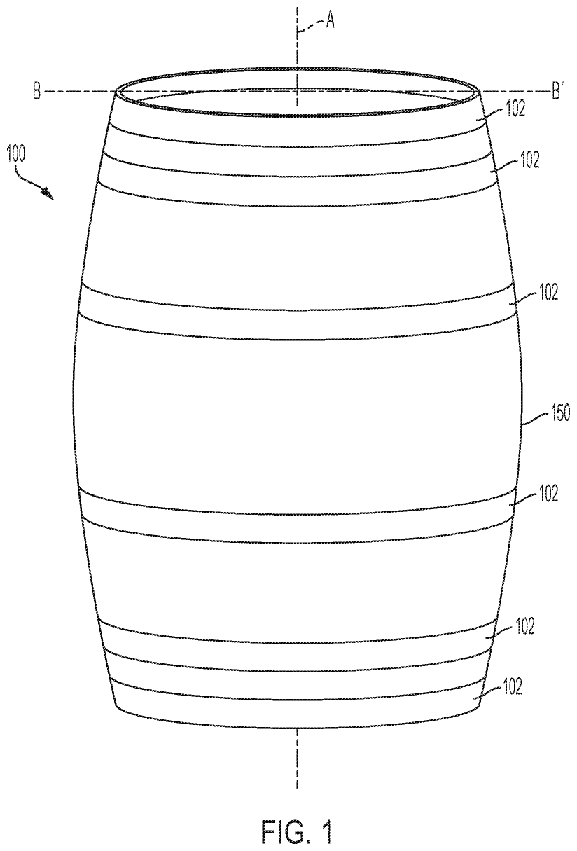

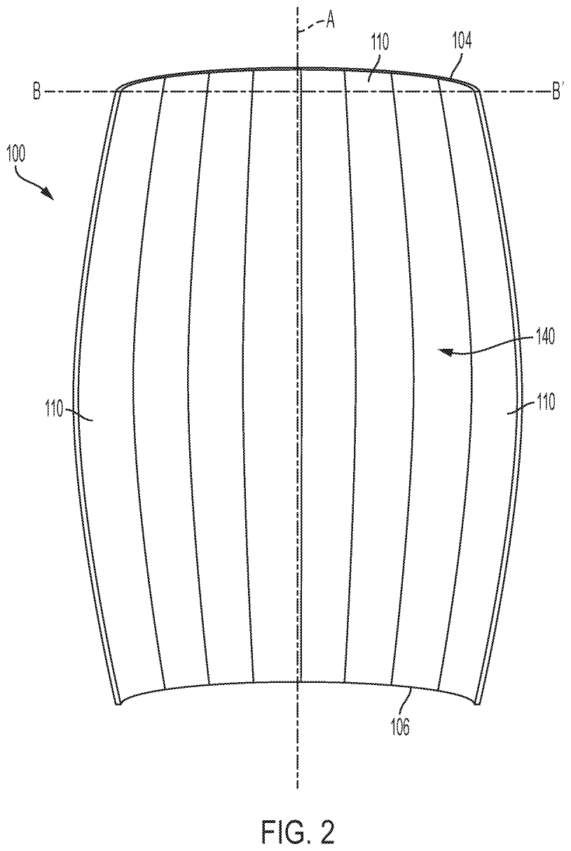

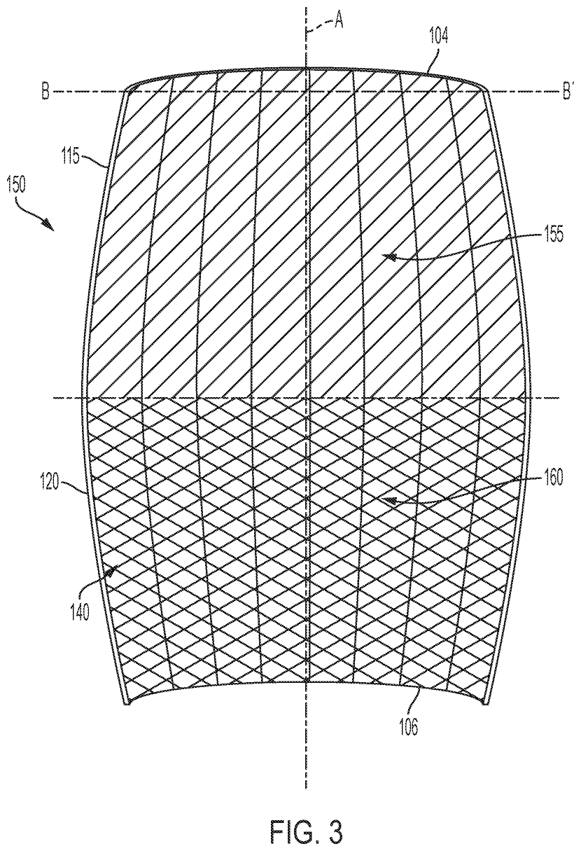

As illustrated in FIG. 1 is toasted barrel 100 for aging wine according to an aspect of the present disclosure. Barrel 100 includes a plurality of staves 110 oriented parallel to a longitudinal axis A to form barrel body 150. The staves are fixed in place using hoops 102. Cutaway view along line B-B′ of FIG. 1 is illustrated in FIG. 2. As shown in FIG. 2, the plurality of staves 110 forming barrel body 150 has an inner circumferential surface or wine contact surface 140. In certain instances, the wine contact surface 140 of the barrel body 150 may be toasted to impart a flavor profile extractable to the wine aged within the barrel 100. In addition, the wine contact surface 140 of the barrel body 150 may include different toasting levels. In these instances, the different portions or areas of the wine contact surface 140 of the barrel body 150 may be crosswise portions as shown in FIGS. 3-6.

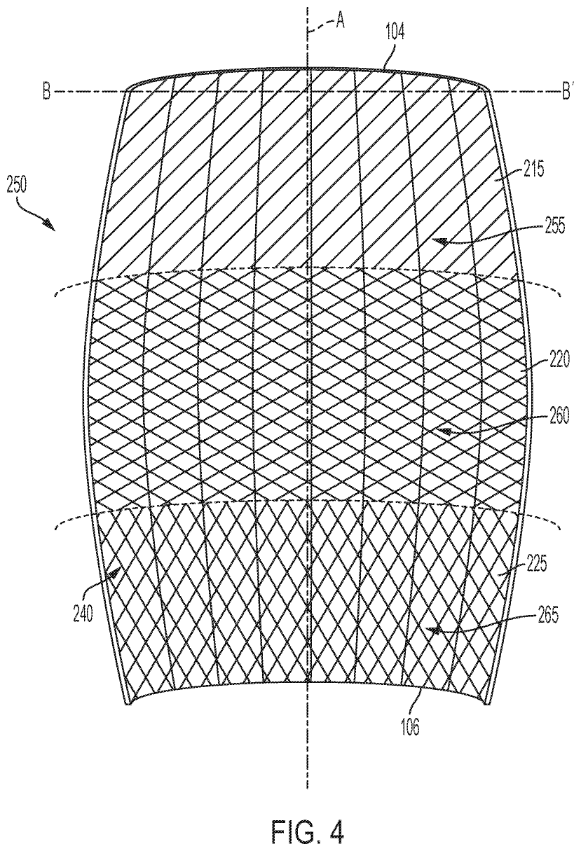

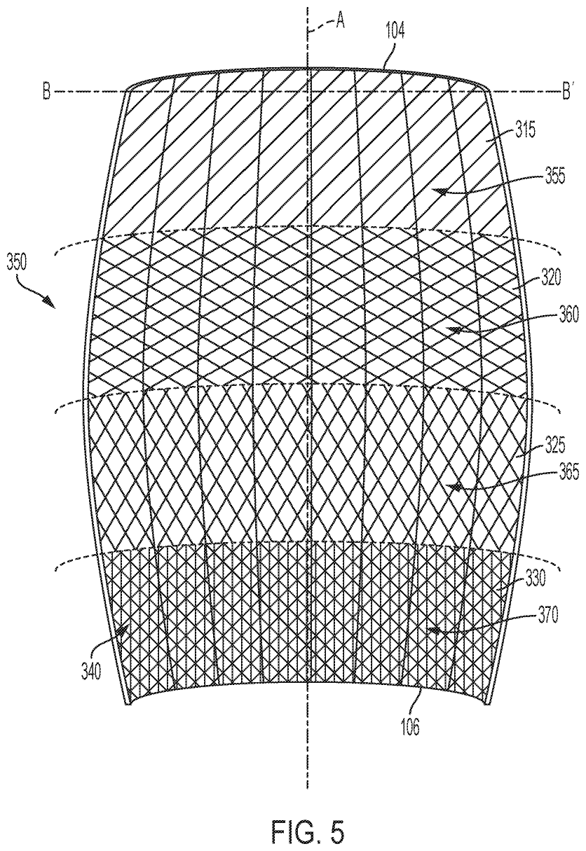

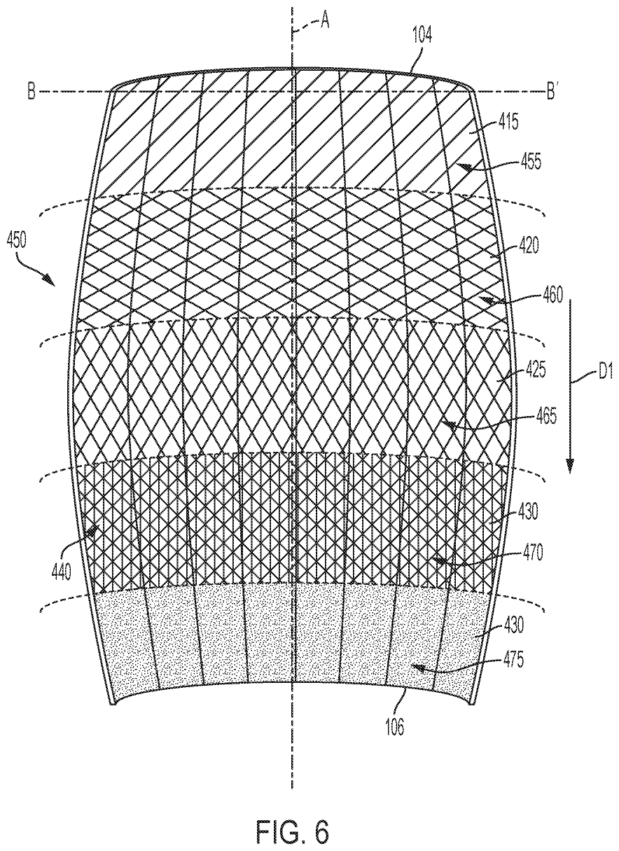

FIGS. 3-6 show barrel bodies 250 having various numbers of portions having different levels of toasting. As described in further detail below, FIG. 3 includes a barrel body 350 having two toast levels, FIG. 4 includes a barrel body 350 having three toast levels, FIG. 5 includes a barrel body 350 having four toast levels, FIG. 6 includes a barrel body 350 having five toast levels. Although a greater number of toast levels may be used, a barrel body 350 having multiple toast levels, and in particular three or more toast levels, may impart different profiles to a wine aged within the barrel 100 as discussed in further detail below. In certain instances, the toast levels discussed below may transition as a gradient across the barrel body 350 or the toast levels may include distinct stopping points between the toast levels. The different structural toast levels of the different crosswise portions impart different flavor profiles extractable to the wine. Advantageously, toasted barrels and staves according to the present disclosure provide structured wines that feature tremendously fruit forward character (abundant upfront fruit sweetness) without the grittiness or smokiness.

FIG. 3 shows a first crosswise portion 115 adjacent to the first end 104 and a second crosswise portion 120 adjacent to a second end 106. The wine contact surface of the first crosswise portion 115 is characterized by a first structural toast level 155 and the wine contact surface of the second crosswise portion 120 is characterized by a second structural toast level 160. In certain instances, the first and second structural toast levels may be unequal or otherwise different. The structural toast levels may be achieved as a result of the toasting conditions (e.g., toast temperature and time) to which the first crosswise portion and the second crosswise portion are exposed. The different structural toast levels may impart different flavor profiles extractable to the wine, as discussed in further detail below. In certain instances, the first structural toast level is configured to release a first flavor profile extractable to the wine and the second structural toast level is configured to release a second flavor profile extractable to the wine. The first and second flavor profiles extractable to the wine may be different.

As shown in FIG. 4, the barrel body 250 having wine contact surface 240 may include three crosswise portions: a first crosswise portion 215 having a first structural toast level 255, a second crosswise portion 220 having a second structural toast level 260, and a third crosswise portion 225 having a third structural toast level 265. In certain instances, the first structural toast level 255 is configured to release a first flavor profile extractable to the wine, the second structural toast level 260 is configured to release a second flavor profile extractable to the wine, and the third structural toast level 265 is configured to release a third flavor profile extractable to the wine. The first, second, and third flavor profiles extractable to the wine may be different. As shown in FIG. 4, a first crosswise portion 215 is adjacent to the first end 104 and a third crosswise portion 225 adjacent to a second end 106.

FIG. 5 shows aa barrel body 350 having a wine contact surface 340 including four crosswise portions: a first crosswise portion 315 having a first structural toast level 355, a second crosswise portion 320 having a second structural toast level 360, a third crosswise portion 325 having a third structural toast level 365, and a fourth crosswise portion 330 having a third structural toast level 370. In certain instances, the first structural toast level 355 is configured to release a first flavor profile extractable to the wine, the second structural toast level 360 is configured to release a second flavor profile extractable to the wine, the third structural toast level 365 is configured to release a third flavor profile extractable to the wine, and the fourth structural toast level 370 is configured to release a fourth flavor profile extractable to the wine. The first, second, third, and fourth flavor profiles extractable to the wine may be different. FIG. 5 shows a first crosswise portion 315 adjacent to the first end 104 and a fourth crosswise portion 330 adjacent to a second end 106.

As shown in FIG. 6, the barrel body 450 having wine contact surface 440 is illustrated including four crosswise portions: a first crosswise portion 415 having a first structural toast level 455, a second crosswise portion 420 having a second structural toast level 460, a third crosswise portion 425 having a third structural toast level 465, a fourth crosswise portion 430 having a third structural toast level 470, and a fifth crosswise portion 435 having a third structural toast level 475. In certain instances, the first structural toast level 455 is configured to release a first flavor profile extractable to the wine, the second structural toast level 460 is configured to release a second flavor profile extractable to the wine, the third structural toast level 465 is configured to release a third flavor profile extractable to the wine, the fourth structural toast level 470 is configured to release a fourth flavor profile extractable to the wine, and the fifth structural toast level 475 is configured to release a fifth flavor profile extractable to the wine. The first, second, third, fourth, and fifth flavor profiles extractable to the wine are different. FIG. 6 shows a first crosswise portion 415 adjacent to the first end 104 and a fifth crosswise portion 435 adjacent to a second end 106.

In certain instances, the structural toast level increases along the barrel body in a first direction D1 parallel to the longitudinal axis A as shown in FIG. 6. In other words, the structural toast level may increase from the first crosswise portion 415 to the second crosswise portion 420 to the third crosswise portion 425 to the fourth crosswise portion 430 to the fifth crosswise portion 435. In certain instances, a gradient from the first crosswise portion 415 to the second crosswise portion 420 to the third crosswise portion 425 to the fourth crosswise portion 430 to the fifth crosswise portion 435 is an increase in the level of toasting.

The different structural toast levels of the different crosswise portions impart different flavor profiles extractable to the wine. For a first structural toast level of a first crosswise portion, the first flavor profile may include at least one flavor characteristic chosen from earthy wood characters, complex baked aromas, mild vanilla component, and combinations thereof. For a second structural toast level of a second crosswise portion, the second flavor profile may include at least one flavor characteristic chosen from toasty aromas of vanillin, coffee and freshly baked bread; round, sweet oak flavors and notes of spice, butterscotch, vanilla, caramel and chocolate; and combinations thereof. For a third structural toast level of a third crosswise portion, the third flavor profile includes at least one flavor characteristic chosen from hazelnut, spice, minerality, mild oak, and combinations thereof. For a fourth structural toast level of a fourth crosswise portion, the fourth flavor profile includes at least one flavor characteristic chosen from vanilla bean, hazelnut, spice, chocolate mocha, oak lactone, brown sugar, and combinations thereof. For a fifth structural toast level of a fifth crosswise portion, the fifth flavor profile includes at least one flavor characteristic chosen from touch of black pepper, mild oak lactones, espresso note, and combinations thereof. These flavor profile characteristics are intended as non-limiting examples.

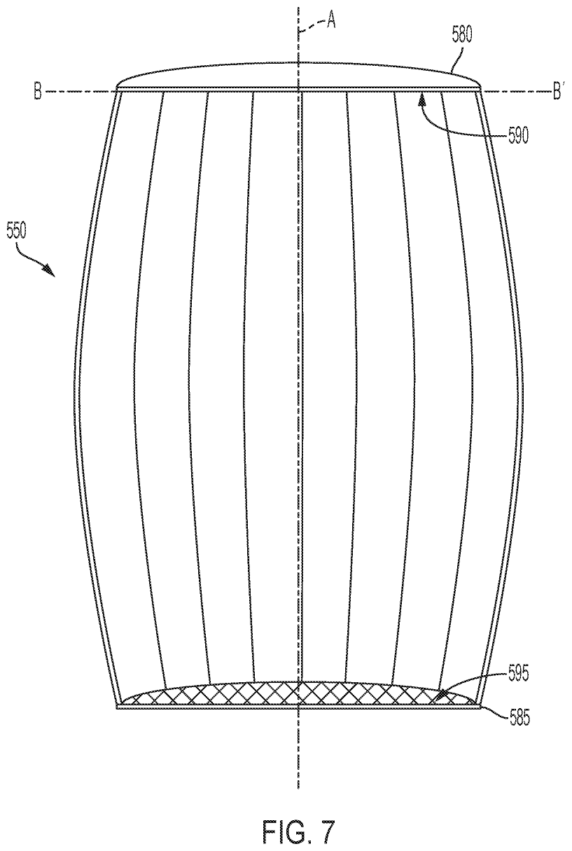

In certain instances, headings including inner surfaces perpendicular to longitudinal axis A also contribute to the wine contact surface. The barrel body, as formed by the staves 110 adjacently aligned as described above, contribute about 70% of the wine contact surface while the two headings together contribute the rest, or about 30%, of the wine contact surface. As shown in FIG. 7, barrel body 550 has a first heading 580 and a second heading 585 including first heading inner surfaces 590 and 595, respectively. In certain instances, first heading inner surface 590 and second heading inner surface 595 are each characterized by at least the first structural toast level. In other embodiments, first heading inner surface 590 and second heading inner surface 595 are each characterized by at least one of the first structural toast level, the second structural toast level, the third structural toast level, the fourth structural toast level, the fifth structural toast level, or a combination thereof. In certain instances, the first heading inner surface and the second heading inner surface are characterized by the same structural toast level. In other embodiments, the first heading inner surface and the second heading inner surface are characterized by different structural toast levels.

In certain instances according to the present disclosure, the staves are made of oak. Upon toasting the multi-level toasted barrel or stave according to the present disclosure, to at least two of the structural toast levels as described above, provides variable oxygen retention and transmission within the wood and, therefore, to the wine contact surface to influence the subsequent flavor profiles imparted to the wine. In certain instances, the oxygen content is more highly retained within the crosswise portion of higher structural toast level than the oxygen content as retained within crosswise portion of lesser structural toast level.

The physical and chemical changes to the wood during toasting contribute to the oxygen content as retained within the wood. For the purposes of the disclosure herein, sequentially from the first crosswise portion to the second crosswise portion to the third crosswise portion to the fourth crosswise portion to the fifth crosswise portion indicates increasing structural toast level, and so on, the oxygen content retention of the wood is increased and available for transmission for extracting flavor profiles to the wine. By specially selecting the staves for their ability to retain oxygen at each distinct toast level the retained oxygen levels of the staves are maximized. This precise process stems from analysis of multiple botanical species of oak (e.g., Quercus Petraea, Quercus Robur, Quercus Alba) from over 50 different distinct geographical regions for retained oxygen after toasting. By applying less and more toast the oxygen levels in an oak stave can be controlled, thereby controlling underlying chemical and physical attributes. The staves will then impact and integrate their flavors into wine faster given that more oxygen is released into the wine. Generally, oxygen causes oxidation of phenolic and volatile compounds and an adequate dose improves the organoleptic characteristics of the wine. In a standard wine barrel, oxygen passes into the wine at a rate near 1 ml/L per month. Mechanical oxygen devices are sometimes applied to increase the rate of oxygen addition into wine to as high 10 ml/L per month or more. Mechanized oxygen additions are inherently limited as to flow rate as they can only add oxygen at a single predetermined set rate. Whereas, having five distinct crosswise portions of a barrel having five distinct toast levels on specific botanical origins of oak provides oxygen impact simultaneously at five levels. That enhances the scope, breadth, and complexity of oxygen dependent polymerization reactions in a wine, notably reducing undesired reductive wine flavors, such as vegetal flavors, while advantageously stabilizing wine colors.

In wine, tannin is a textural element that makes wine taste dry and astringent. Tannin is a naturally occurring polyphenol found in plants, seeds, bark, wood, leaves, and fruit skins. Tannin levels of the multi-level toast barrels or stave according to the present disclosure may be tailored to the preference of the winemaker. For the purposes of the disclosure herein, sequentially from the first crosswise portion to the second crosswise portion to the third crosswise portion to the fourth crosswise portion to the fifth crosswise portion indicates increasing structural toast level, and so on, the tannin content of the wood is decreased for extracting mitigated tannin flavor profiles to the wine.

Cis- (and trans-) oak lactone are flavor compound(s) in wine that impart a variety of sensory characteristics and are responsible for the greater intensity of vanilla and coconut-like aromas found in wines matured in different types of oak. These lactones are present in the raw material and may vary substantially among different wood samples. The oak lactone amounts present in oak can be affected by seasoning but not in a predictable way. The presence of these compounds in oak is not greatly affected by coopering variation but, in some samples, increasing toasting levels can slow down the rate of lactone extraction and reduce their impact on wine flavor. For the purposes of the disclosure herein, and sequentially from the first crosswise portion to the second crosswise portion to the third crosswise portion to the fourth crosswise portion to the fifth crosswise portion indicates increasing structural toast level, and so on, the oak lactone content of the wood is decreased for extracting mitigated, or eliminating altogether, flavor profiles to the wine.

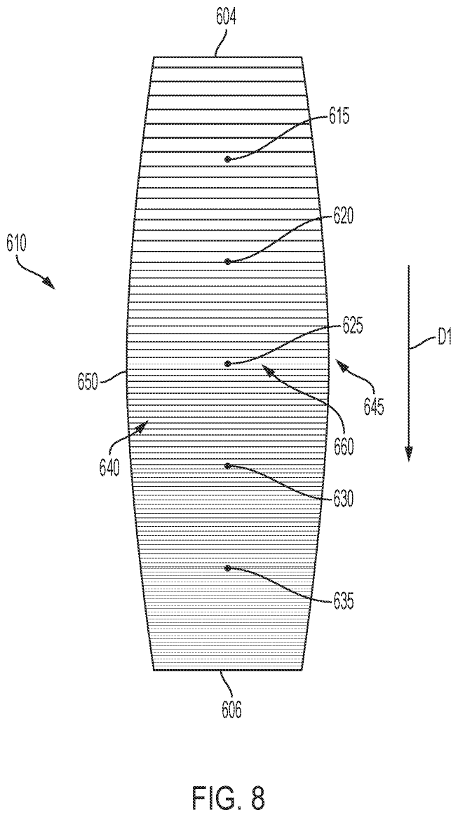

As illustrated in FIG. 8 is toasted stave 610 for use in a barrel for aging wine. Toasted stave 610 includes an elongated body portion 650 having a first end 604 and a second end 606. End 606 is opposite end 604. Body portion 650 includes an inner surface 640, which is the surface configured to contact wine. Body portion 650 includes an outer surface 645 opposite inner surface 640. Inner surface 640 includes a gradient 660 in a first direction D1 from the first end 604 to the second end 606, wherein the gradient 660 is an increase in the level of toasting. The gradient 660 has at least two different levels of toasting including a first level of toasting 615 and a second level of toasting 620, wherein the second level of toasting 620 is greater than the first level of toasting 615. Inner surface 640 including gradient 660 may further comprise a third level of toasting 625, wherein the third level of toasting 625 is greater than the second level of toasting 620. Inner surface 640 including gradient 660 may further comprise a fourth level of toasting 630, wherein the fourth level of toasting 630 is greater than the third level of toasting 625. Inner surface 640 including gradient 660 may further comprise a fifth level of toasting 635, wherein the fifth level of toasting 635 is greater than the fourth level of toasting 630. In certain instances, the gradient from the first end 604 to the second end 606 is continuous (as schematically shown in FIG. 8). In other embodiments, the gradient from the first end 604 to the second end 606 is discontinuous or incremental (not shown). In certain instances, the first level of toasting is untoasted. In other embodiments, the first level of toasting is a light structural toast.

In certain instances, the stave 610 is made of oak, wherein oxygen is retained within the oak. The inner surface 640 of stave 650 further comprises an oxygen content gradient in a first direction D1 from the first end 604 to the second end 606, wherein the oxygen content gradient is an increase in the oxygen content retained within the oak. The inner surface further comprises a color gradient in a first direction D1 from the first end 604 to the second end 606, wherein the color gradient is an increase in the darkness of the color.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

Moreover, though the description of the disclosure has included description of one or more aspects, embodiments, or configurations and certain variations and modifications, other variations, combinations, and modifications are within the scope of the disclosure, for example, as may be within the skill and knowledge of those in the art, after understanding the present disclosure. It is intended to obtain rights which include alternative aspects and configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A toasted barrel for aging wine, the toasted barrel comprising:
a plurality of staves oriented parallel to a longitudinal axis, the plurality of staves forming a barrel body having a wine contact surface, the barrel body having at least a first crosswise portion and a second crosswise portion, wherein the wine contact surface of the first crosswise portion is characterized by a first structural toast level and the wine contact surface of the second crosswise portion is characterized by a second structural toast level, the first structural toast level configured to release a first flavor profile extractable to the wine and the second structural toast level configured to release a second flavor profile extractable to the wine.

2. The toasted barrel of claim 1, further comprising:
a third crosswise portion, wherein the wine contact surface of the third crosswise portion is characterized by a third structural toast level, the third structural toast level configured to release a third flavor profile extractable to the wine.

3. The toasted barrel of claim 2, further comprising:
a fourth crosswise portion, wherein the wine contact surface of the fourth crosswise portion is characterized by a fourth structural toast level, the fourth structural toast level configured to release a fourth flavor profile extractable to the wine.

4. The toasted barrel of claim 3, further comprising:
a fifth crosswise portion, wherein the wine contact surface of the fifth crosswise portion is characterized by a fifth structural toast level, the fifth structural toast level configured to release a fifth flavor profile extractable to the wine.

5. The toasted barrel of claim 1, wherein the structural toast level increases along the barrel body in a first direction from the first crosswise portion to the second crosswise portion.

6. The toasted barrel of claim 1, further comprising a first heading inner surface and a second heading inner surface each characterized by at least the first structural toast level.

7. The toasted barrel of claim 1, wherein the staves are made of oak and oxygen is retained within the oak.

8. The toasted barrel of claim 7, wherein the oxygen content retained within the second crosswise portion is higher than the oxygen content retained within the first crosswise portion.

9. The toasted barrel of claim 8, wherein the tannin content retained within the second crosswise portion is less than the tannin content retained within the first crosswise portion.

10. The toasted barrel of claim 4, wherein:
the first flavor profile includes at least one flavor characteristic chosen from earthy wood characters, complex baked aromas, mild vanilla component, and combinations thereof;
the second flavor profile includes at least one flavor characteristic chosen from toasty aromas of vanillin, coffee and freshly baked bread; round, sweet oak flavors and notes of spice, butterscotch, vanilla, caramel and chocolate; and combinations thereof;
the third flavor profile includes at least one flavor characteristic chosen from hazelnut, spice, minerality, mild oak, and combinations thereof;
the fourth flavor profile includes at least one flavor characteristic chosen from vanilla bean, hazelnut, spice, chocolate mocha, oak lactone, brown sugar, and combinations thereof; and,
the fifth flavor profile includes at least one flavor characteristic chosen from touch of black pepper, mild oak lactones, espresso note, and combinations thereof.

11. A toasted stave for use in a barrel for aging wine, the toasted stave comprising:
an elongated body portion having:
a first end and a second end opposite to the first end,
an inner surface, and
an outer surface;
wherein the inner surface includes a gradient in a first direction from the first end to the second end, wherein the gradient is an increase in the level of toasting.

12. The toasted stave of claim 11, further comprising the gradient having at least two different levels of toasting including:
a first level of toasting; and,
a second level of toasting, the second level of toasting greater than the first level of toasting.

13. The toasted stave of claim 12, further comprising a third level of toasting, the third level of toasting greater than the second level of toasting.

14. The toasted stave of claim 13, further comprising a fourth level of toasting, the fourth level of toasting greater than the third level of toasting.

15. The toasted stave of claim 14, further comprising a fifth level of toasting, the fifth level of toasting greater than the fourth level of toasting.

16. The toasted stave of claim 11, wherein the gradient from the first end to the second end is continuous.

17. The toasted stave of claim 11, wherein the gradient from the first end to the second end is discontinuous.

18. The toasted stave of claim 11, wherein the first level of toasting is untoasted.

19. The toasted stave of claim 11, wherein the stave is made of oak, and wherein oxygen is retained within the oak, wherein the inner surface further comprises an oxygen content gradient in a first direction from the first end to the second end, wherein the oxygen content gradient is an increase in the oxygen content retained within the oak.

20. The toasted stave of claim 11, wherein the inner surface further comprises a color gradient in a first direction from the first end to the second end, wherein the color gradient is an increase in the darkness of the color.
